(19) United States
(12) Patent Application Publication
(10) Pub. No.: US 2011/0069669 A1
(43) Pub. Date: Mar. 24, 2011

(54) SYSTEM AND METHODS FOR SENDING AND RECEIVING PAN (PIGGY-BACKED ACK/NACK) SO AS TO AVOID DECODING CONFUSION

(75) Inventors: Johanna Lisa Dwyer, Ottawa (CA); David Philip Hole, North Baddesley (GB); Dennis Conway, Mississauga (CA); Satish Venkob, Waterloo (CA)

(73) Assignee: RESEARCH IN MOTION LIMITED, Waterloo (CA)

(21) Appl. No.: 12/879,822

(22) Filed: Sep. 10, 2010

Related U.S. Application Data
(60) Provisional application No. 61/241,715, filed on Sep. 11, 2009.

(51) Int. Cl. H04W 72/04

(52) U.S. Cl. 370/329

(57) ABSTRACT

There may be ambiguity when ACK/NACK information is transmitted. In some cases the ambiguity may arise because a bit may be either a padding bit, or an ACK/NACK bit having the same value as a padding bit. In other cases, the ambiguity may arise where it is unclear whether the ACK/NACK is in respect of a first transmission of a data block, or a subsequent transmission of the same data block. Various schemes provided to address this. In some cases, the mobile station is mandated to apply a consistent behaviour. Over time, the network can deduce the behaviour. In some cases the mobile station transmits signaling that conveys the behaviour.

### CROSS REFERENCE TO RELATED APPLICATIONS

This application claims the benefit of U.S. Provisional Application No. 61/241,715 filed Sep. 11, 2009 hereby incorporated by reference in its entirety.

### FIELD

The application relates to systems and methods for sending and receiving piggy-backed ACK/NACK information.

### BACKGROUND

### Abbreviations

| | |
|---|---|
| BSC | base station controller |
| BSS | base station subsystem (for |
| | example comprising BSC + BTS) |
| BTS | base transceiver station |
| DL | Downlink |
| DLDC | downlink dual carrier |
| GERAN | GPRS/EDGE radio access |
| | network |
| GPRS | General Packet Radio Service |
| MS | mobile station |
| NPM | non-persistent mode |
| QBP | Questionable radio block period |
| RLC | radio link control |
| RTTI | reduced transmission time interval |
| TBF | temporary block flow |
| TCP | transmission control protocol |
| UL | Uplink |
| USF | uplink state flag |
| TDMA | Time division multiple access |

A BTTI (Basic Transmit Time Interval) block consists of a slot allocated over four consecutive frames. For example, frame 1 slot 1, frame 2 slot 1, frame 3 slot 1 and frame 4 slot 1 make up a BTTI block. In some implementations, a frame is approximately 5 ms in duration, such that a BTTI block will span over four frames, or a 20 ms interval. A BTTI TBF is a TBF which uses BTTI blocks.

An RTTI (Reduced Transmit Time Interval) block uses the same frame structure introduced above, but an RTTI block consists of a pair of slots during a first frame, and a pair of slots during the next frame such that an RTTI block will span over two frames or a 10 ms interval. An RTTI TBF is a TBF which uses RTTI blocks. The transmission interval for an RTTI block compared to a BTTI block is reduced by half.

To perform uplink BTTI allocation, the network transmits a USF (uplink state flag) during a downlink BTTI block in a downlink slot of a preceding block period. The mobile station is thereby allocated a timeslot for uplink transmission of an uplink BTTI block that has the same number as that of the downlink slot used to transmit the USF.

The transmissions from a BTS during a given radio block period may contain zero, one, or more than one blocks for a given mobile station, each block having a respective block sequence number.

To perform RTTI allocation, the network transmits USF signaling during the previous radio block period on a pair of timeslots. The mobile station is allocated a pair of uplink timeslots for transmission of an uplink RTTI block, these slots being defined as the “corresponding slot pair” or “corresponding PDCH (packet data channel)—pair” to the downlink pair used to transmit the USF. The corresponding uplink slots may or may not be the same as the downlink slots used to transmit USFs.

There is also a hybrid version of RTTI allocation where two BTTI USFs are used to allocate two RTTI blocks. Specifically, a first BTTI USF is used to allocate an RTTI radio block in the first two frames of the four frames that follow the two BTTI USFs, and a second BTTI USF is used to allocate an RTTI block in the second two frames of the four frames the follow the two BTTI USFs.

The feature “Latency Reductions” was added to EGPRS in 3GPP Release 7. One aspect of this feature is so-called “Fast Ack/Nack Reporting” (FANR).

Without FANR, all RLC acknowledgements (that is, indications by the receiver of RLC data blocks whether it had correctly received RLC data blocks sent by the transmitter) were done by means of “Packet Ack/Nack” messages, such as EGPRS Packet Downlink ACK/NACK messages, or Packet Uplink ACK/NACK messages. These messages are RLC/MAC control messages and did not contain any RLC data (though they may contain other RLC/MAC control information besides acknowledgement information).

The disadvantage of this approach is that it is quite inefficient, particularly when acknowledgement information needs to be sent quickly (e.g. in order to allow fast retransmissions of erroneously received blocks) or when the status of very few blocks needs to be indicated (e.g. in low bandwidth transmissions). In either scenario, the amount of acknowledgement information that is actually useful is very small compared to the capacity of an RLC/MAC control block.

The FANR feature allows piggy-backing of a small amount of acknowledgement information together with one or more RLC data blocks. In this case, the acknowledgement information is referred to as a PAN (piggy-backed Ack/Nack) field.

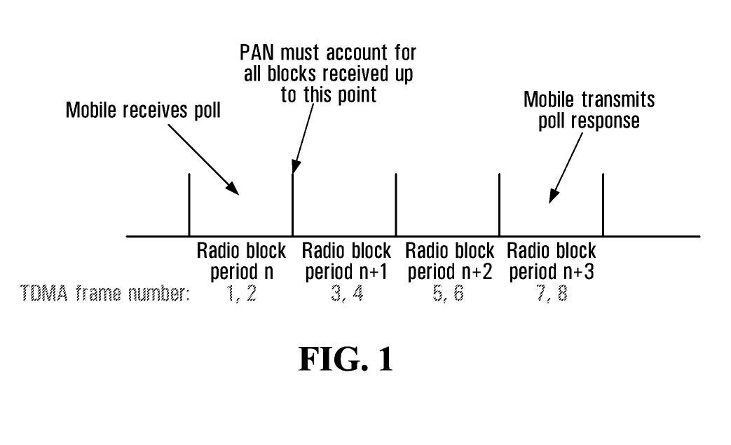

An example of an exchange between a network and a mobile station involving the PAN field is depicted in FIG. 1.

Note that polls that request an uplink transmission in a given radio block period are sent much earlier than USFs which allocate resources in the same radio block period. It is possible that a poll and a USF may refer to the same uplink transmission opportunity (this is well-known and taken into account by the network when performing scheduling).

In the case of a PACCH block or a PAN field, the mobile station is allowed a minimum of 4 TDMA frames periods (approx. 20 ms) to encode the PACCH block or PAN field (ref: table 10.4.4b in 44.060—here it is stated that the shortest delay between the start of the poll transmission and the start of the response is 6 TDMA frames; considering that the end of the poll is received 2 TDMA frame periods after the start of the transmission of the poll, this leaves 4 TDMA frame periods for constructing and encoding the response).

In addition to sending a PAN in response to a poll, a mobile station may be required to send PANs ‘pro-actively’ based on the status of the data blocks it has received. This is referred to as Event-based FANR. Essentially, if Event-based FANR is enabled, the mobile station is expected to report, by means of a PAN sent at the earliest opportunity, missing blocks.

In order to specify this behaviour, data blocks which are known to be missing are classified as either REPORTED, or UNREPORTED. On initial detection of a missing block, the status of that block is set to UNREPORTED; when the status of that block is indicated by means of any Ack/Nack information (need not necessarily be a PAN), the state is set to REPORTED. If Event-based FANR is active, mobile stations are required to insert PANs into UL data blocks for as long as there exists (downlink) blocks with the status UNREPORTED.

A “missing” data block may be detected either by out-of-sequence reception (e.g. receiving block 4 before block 3 has been received would indicate that block 3 is missing) or by decoding the block header (which includes the block sequence number) but failing to decode the data portion correctly.

The current specifications indicate that:

considering BTTI operation (where 1 BTTI radio block period=4 TDMA frames), the reaction time for the mobile station is such that if a mobile station determines at the end of block period n that a PAN is to be sent, the PAN is to be sent (or possible to be sent, if event-based) in block period n+2.

considering RTTI operation (where 1 RTTI radio block period=2 TDMA frames), the reaction time for the mobile station is such that if a mobile station determines at the end of block period n that a PAN is to be sent, the PAN is to be sent (or possible to be sent, if event-based) in block period n+3.

The reaction times referred to above ignore TDMA frames which may be used for neighbour cell measurements, etc. generally referred to as ‘idle’ or ‘search’ frames.

A PAN sent in response to the poll includes a bitmap; the bitmap is a sequence of 1's and 0's corresponding to a consecutive sequence of block sequence numbers (BSNs) plus (optionally) some padding. Each bit indicates an ACK or NACK for the block having the block sequence number. The PAN also includes information from which the BSN of the first (lowest) BSN being reported can be determined. A detailed example of PAN construction is defined in Detailed Example A which appears near the end of this description. In some cases, a bitmap is generated which is not full, in the sense that there is a fixed size for the bitmap, but there are fewer blocks to acknowledge than allowed for by the size of the bitmap. In this case, the bitmap includes a bit for each of the blocks, and is then padded, for example with 0's to complete the bitmap. The transmission of blocks is not necessarily in numerical order, for example because of retransmissions. Thus, correspondingly the mapping of bits in the PAN bitmap is not necessarily in accordance with the order in which the blocks were transmitted.

In an example of a possible constraint on bitmap generation, for polled PANs, 44.060 v.7.17.0, sub-clause 9.1.8.2.3, it is stated:

### 9.1.8.2.3 Generation of the Bitmap

[. . . ]

For EGPRS TBFs using downlink dual carrier configuration, with FANR activated or using EGPRS2 and for EGPRS TBFs running in RLC non-persistent mode, when the mobile station is polled, V(R) shall be determined taking into account all RLC data blocks received up to and including those received in the radio block period where the poll is received. As an implementation option, the mobile station may also consider RLC data blocks that are received in following radio block periods, taking into account all RLC data blocks received in those radio block periods.

[. . . ]

Note that there is no similar corresponding text for event-based PANs.

### DETAILED DESCRIPTION

One broad aspect of the application provides a method in a network, the method comprising: receiving signaling information from a mobile station, the signaling information indicating which radio block periods are considered by a mobile station when generating a bitmap containing ACK/NACK (acknowledgement/negative acknowledgement) information; receiving a bitmap containing ACK/NACK information; processing the ACK/NACK information in accordance with the signaling information.

Another broad aspect of the application provides a method in a mobile station, the method comprising: transmitting signaling information from the mobile station in respect of mobile station behaviour when generating a bitmap containing ACK/NACK information, the signaling information indicating which radio block periods are considered when generating the bitmap; generating a bitmap containing ACK/NACK information in accordance with the signaling information; and transmitting the bitmap containing ACK/NACK information.

Another broad aspect of the application provides a method in a network, the method comprising: receiving a bitmap containing ACK/NACK information; attempting to validate a bit received as part of the ACK/NACK information as an ACK/NACK in respect of a data block transmitted to a mobile station during a radio block period subsequent to a first radio block period; upon successfully validating the bit, making a conclusion that the mobile station included ACK/NACK information for data blocks transmitted during the radio block period subsequent to the first radio block period, and processing the ACK/NACK information accordingly.

In some embodiments, receiving a bitmap containing ACK/NACK information comprises receiving a bitmap that contains at least one bit known to be an ACK/NACK bit and that contains at least one bit that may be an ACK/NACK bit or a padding bit; attempting to validate a bit comprises attempting to validate at least one bit that may be an ACK/NACK bit or a padding bit.

In some embodiments, attempting to validate a bit comprises determining the bit is not the same as a padding bit.

In some embodiments, attempting to validate a bit comprises determining that the bit is an ACK/NACK in respect of a data block transmitted during the radio block period subsequent to the first radio block period, and not some earlier transmission of the data block.

In some embodiments, the method further comprises ignoring ACK/NACK information in respect of data blocks transmitted in one or more radio block periods subsequent to the first radio block period for which there has been no successful validation.

In some embodiments, the method further comprises having validated a bit to be an ACK/NACK in respect of a radio block received during a particular radio block period, concluding that a bit that may be an ACK/NACK in respect of a radio block received during a future radio block period is also validated based on an understanding that the mobile station is mandated to apply the same behaviour consistently over a period of time.

Another broad aspect of the application provides a method in a network comprising: receiving ACK/NACK information that contains at least one bit that is unambiguous in its meaning and that contains at least one bit that is ambiguous in its meaning; resolving the ambiguity in the meaning of the at least one bit that is ambiguous in its meaning based on an expectation the same behaviour will be applied consistently over a period of time.

In some embodiments, receiving ACK/NACK information that contains at least one bit that is ambiguous in its meaning comprises: receiving ACK/NACK information that contains at least one bit that is either an ACK/NACK bit in respect of a data block transmitted subsequent to a first radio block period or a padding bit.

In some embodiments, resolving the ambiguity in the meaning of the at least one bit based on an expectation the same behaviour will be applied consistently over a period of time comprises: selecting between processing the at least one bit that may be an ACK/NACK bit or a padding bit as an ACK/NACK bit or a padding bit based on an expectation the same behaviour will be applied consistently over a period of time.

In some embodiments, receiving ACK/NACK information that contains at least one bit that is ambiguous in its meaning comprises: receiving ACK/NACK information that contains at least one bit that is either an ACK/NACK bit in respect of a data block transmitted in a first radio block period or and ACK/NACK bit in respect of the data block transmitted in a second radio block period.

In some embodiments, the method comprises polling a mobile station in a radio block period; wherein receiving ACK/NACK information that contains at least one bit that is unambiguous in its meaning comprises receiving ACK/NACK information all data blocks received up to and including those received in the radio block period where the poll is received; wherein receiving ACK/NACK information that contains at least one bit that is ambiguous in its meaning comprises receiving at least one ACK/NACK bit in respect of at least one radio block period following the radio block period where the poll is received, or receiving at least one padding bit.

In some embodiments, said period of time comprises a duration of a TBF (temporary block flow) as long as a TTI (transmission time interval) of an uplink resource remains the same.

In some embodiments, the bitmap is a current bitmap that was transmitted during radio block period m; selecting between processing the at least one bit that may be an ACK/NACK bit or a padding bit as an ACK/NACK bit or a padding bit based on an expectation the same behaviour will be applied consistently over a period of time comprises: upon having determined that for a previously transmitted bitmap in radio block period n, the previously transmitted bitmap includes ACK/NACK information for data blocks received during and prior to radio block period n−a, processing the current bitmap as if it includes ACK/NACK information for data blocks received during and prior to radio block period m−a.

In some embodiments, receiving ACK/NACK information that contains at least one bit that is unambiguous in its meaning comprises receiving ACK/NACK information for all data blocks received up to and including those received in the radio block period in which an event occurred that triggered transmission of the ACK/NACK information; wherein receiving ACK/NACK information that contains at least one bit that is ambiguous in its meaning comprises receiving at least one ACK/NACK bit in respect of at least one radio block period following the radio block period in which an event occurred that triggered transmission of the ACK/NACK information, or receiving at least one padding bit.

In some embodiments, said period of time comprises a duration of a TBF (temporary block flow) as long as a TTI (transmission time interval) of an uplink resource remains the same.

In some embodiments, the bitmap is a current bitmap that was transmitted during radio block period m; selecting between processing the at least one bit that may be an ACK/NACK bit or a padding bit as an ACK/NACK bit or a padding bit based on an expectation the same behaviour will be applied consistently over a period of time comprises: upon having determined that for a previously transmitted bitmap in radio block period n, the previously transmitted bitmap includes ACK/NACK information for data blocks received during and prior to radio block period n−a, processing the current bitmap as if it includes ACK/NACK information for blocks received during and prior to radio block period m−a.

Another broad aspect of the application provides a method in a mobile station, the method comprising: transmitting a bitmap containing ACK/NACK information; in respect of one or more radio block periods subsequent to a first block period for which, from the perspective of a recipient of the bitmap the mobile station has the option of including ACK/NACK information in the bitmap or not: generating the bitmap so as to include ACK/NACK information for one or more data blocks that are received by the mobile station in the one or more radio block periods subsequent to a first block period, subject to a requirement that the mobile station apply the same behaviour consistently over a period of time.

In some embodiments, generating the bitmap so as to include ACK/NACK information for one or more data blocks that are received by the mobile station in one or more periods subsequent to a first block period, subject to a requirement that the mobile station apply the same behaviour consistently over a period of time comprises: if the bitmap is transmitted in radio block period n, and the bitmap includes ACK/NACK information for data blocks received during and prior to radio block period n−a, the same value of a shall be used.

In some embodiments, the method comprises during the first radio block period, receiving a poll for ACK/NACK information; wherein generating the bitmap further comprises including in the bitmap ACK/NACK information for data blocks received up to and including those received during the first radio block period.

In some embodiments, the bitmap is a current bitmap that is transmitted during radio block period m; generating the bitmap so as to include ACK/NACK information for one or more data blocks that are received by the mobile station in one or more radio block periods subsequent to a first block period, subject to a requirement that the mobile station apply the same behaviour consistently over a period of time comprises: upon having previously generated a bitmap in radio block period n that includes ACK/NACK information for data blocks received during and prior to radio block period n−a, generating the bitmap including NACK/NACK information for data blocks received during and prior to radio block period m−a in the current bitmap.

In some embodiments, generating the bitmap so as to include ACK/NACK information for one or more data blocks that are received by the mobile station in one or more radio block periods subsequent to a first block period, subject to a requirement that the mobile station apply the same behaviour consistently over a period of time comprises: if the bitmap is transmitted in radio block period n, and the bitmap includes ACK/NACK information for data blocks received during and prior to radio block period n−a, the same value of a shall be used.

In some embodiments, the method comprises detecting an event triggering transmission of ACK/NACK information during the first radio block period; wherein generating the bitmap further comprises including in the bitmap ACK/NACK information for data blocks received up to and including those received during the first radio block period.

In some embodiments, the bitmap is a current bitmap that is transmitted during radio block period m; generating the bitmap so as to include ACK/NACK information for one or more data blocks that are received by the mobile station in one or more radio block periods subsequent to a first block period, subject to a requirement that the mobile station apply the same behaviour consistently over a period of time comprises: upon having previously generated a bitmap in radio block period n that includes ACK/NACK information for data blocks received during and prior to radio block period n−a, generating the bitmap including ACK/NACK information for data blocks received during and prior to radio block period m−a in the current bitmap.

In some embodiments, generating the bitmap so as to include ACK/NACK information for one or more data blocks that are received by the mobile station in one or more radio block periods subsequent to a first block period, subject to a requirement that the mobile station apply the same behaviour consistently over a period of time comprises: if the bitmap is transmitted in radio block period n, and the bitmap includes ACK/NACK information for data blocks received during and prior to radio block period n−a, the same value of a shall be used.

In some embodiments, the bitmap containing ACK/NACK information is contained within a piggy-backed ACK/NACK (PAN) field.

In some embodiments, said period of time comprises a duration of a TBF (temporary block flow) as long as a TTI (transmission time interval) of an uplink resource remains the same.

Another broad aspect provides a mobile station configured to execute one of the methods summarized above.

Another broad aspect provides a computer readable medium having computer executable instructions stored thereon, which, when executed on a mobile station, result in the execution of one of the methods summarized above.

Another broad aspect provides one or more network components configured to execute one of the methods of summarized above.

Another broad aspect provides a computer readable medium having computer executable instructions stored thereon, which, when executed on one or more network components, result in the execution of one of the methods summarized above.

As indicated in the background, due to the “implementation option” allotted to the mobile station, the MS may consider RLC data blocks that are received in the following block periods (following the block period within which the poll was received), taking into account all the RLC data blocks received in those periods.

By providing timely ACK/NACK information to the network, it may be possible to avoid unnecessary retransmission of blocks that the mobile station has successfully received, and to trigger retransmissions of blocks that the mobile station has not yet received correctly. While the implementation option indicated above clearly allows for the mobile station to include timely information, this option may result in ambiguity in the interpretation of a PAN field, negating the benefits of the timely reporting.

A problem is that the network does not know a priori to what extent (if any) the mobile station is making use of this implementation option. More specifically, the network may not be able to determine whether the mobile station is generating a PAN taking account of RLC data blocks that are received in radio block periods following the poll, taking into account all RLC data blocks received in those radio block periods, as allowed by, but not mandated by 44.060 v.7.17.0, sub-clause 9.1.8.2.3.

This leads to two possibilities for ambiguity or confusion. The first possibility for confusion stems from the lack of distinction between padding bits and ACK/NACK bits. For example, in 3GPP TS 44.060 v. 7.17.0, padding bits and NACK indications both use a ‘0’ indication. As such, the network may not be able to tell if a particular bit in a bitmap is a padding bit as opposed to a NACK if the bit position corresponds with a block transmitted during a questionable radio block period. This is illustrated in examples described below.

The second possibility of confusion stems from not knowing whether the generation of a particular ACK/NACK bit has taken into account a particular transmission of a block. In some cases, the network may be able to determine that the status of a particular block (which may be identified by its sequence number) is reported within the bitmap. However, if multiple instances of that block have been transmitted, the network may not be able to determine which instances the ACK/NACK information relates to, and in particular whether the ACK/NACK information takes account of the most recent transmissions of that block. This second possibility for confusion arises where the status of a block is reported in the bitmap, but the network had transmitted multiple instances of the block, including one or more instances transmitted before or during the last radio block period for which the status of received block must be taken into account by a mobile station when constructing a PAN, and one or more instances transmitted during subsequent radio block periods (but before the PAN is transmitted). The network may not be able to determine whether or not the mobile station report has taken into account the latter transmission(s). This is illustrated in Example 3.

This second possibility for confusion arises not only in PAN bitmaps, but also in other bitmap-based ACK/NACK information where each bit corresponds to a particular block (and does not explicitly distinguish the status of multiple individual transmissions of the same block) and where the mobile station has some flexibility in determining the instant in time at which the status of received blocks is reported. For example, this applies in the case of EGPRS PACKET DOWNLINK ACK/NACK messages and EGPRS PACKET DOWNLINK ACK/NACK TYPE 2 messages sent by mobile stations operating using a downlink dual carrier configuration, using the EGPRS2 feature, or running in RLC non-persistent mode (see 3GPP TS 44.060 v.7.17.0). This second type of confusion arises even when there is no padding or where the end of the bitmap is explicitly indicated, hence the solutions below apply in this case as well.

These two possibilities for confusion will now be described in detail by way of example. Examples 1, 2, 3 and 4 are provided below to illustrate this problem.

Considering RTTI, the timeline for a poll and response is as shown in FIG. 1, where the TDMA frame numbers assume that there are no ‘search’/idle frames in the sequence. In radio block period n, the mobile station receives the poll. For RTTI, the mobile station transmits a response to the poll 3 radio block periods later, namely in radio block period n+3. The PAN transmitted by the mobile station accounts for radio blocks received up to and including the radio block period within which the mobile station receives the poll, to the extent capacity of the PAN makes this possible. The mobile station may (according to 44.060 v.7.17.0, sub-clause 9.1.8.2.3) additionally report blocks received during radio block periods n+1 and n+2.

### EXAMPLE 1

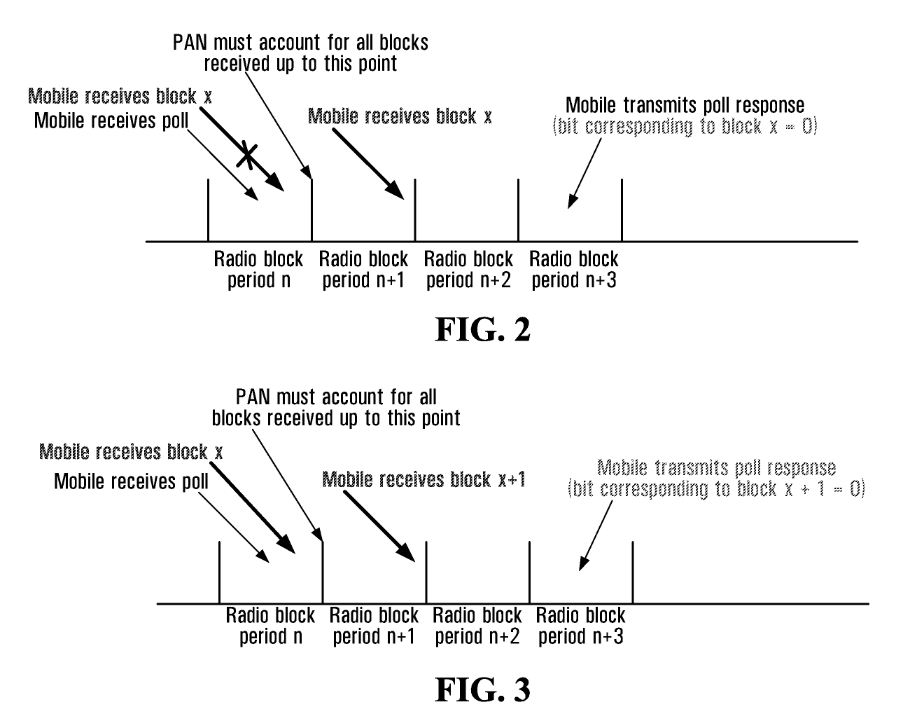

With reference to FIG. 2, during block period n, the mobile station receives data block x, but with errors. During block period n, the mobile station also receives a poll for a PAN. During block period n+1, the mobile station receives a (pre-emptive—in the sense that the network is retransmitting even though it doesn't at this stage know whether the retransmission is needed or not) retransmission of block x. During block period n+3, the mobile station transmits a PAN:

if the PAN indicates an ACK (where ACK=1 for this example) for block x, the network knows that the mobile station received at least one copy of block x correctly

if the PAN indicates a 0 (where NACK=0 for this example) for block x, the network does not know if:
i) the mobile station did not receive x correctly during block n, and did not take into account the reception of block x during block n+1 when building the PAN) or
ii) the mobile station did not receive either transmission of block x (during block n or during block n+1) correctly, and did take into account the reception of block x during block n+1 when building the PAN by sending a ‘0’.

Since the network cannot determine which of the above is the case, it does not know whether the mobile station took account of block n+1 when building the PAN, and hence it cannot determine whether or the mobile station has received block x correctly.

### EXAMPLE 2

With reference to FIG. 3, the mobile station receives block x+1 during block period n+1. The mobile station transmits in its poll response a NACK indication for block x+1 (because block x+1 was not correctly received). Because the same value (0) is used both for ‘padding’ (that is, for sequence numbers which the mobile station has not yet received and does not consider missing) and for NACK indications, the network cannot tell whether this 0 is a padding zero (because the mobile station took account only of blocks received up to block period n) or a NACK zero (because the mobile station took account of block period n+1 and did not correctly receive block x+1).

### EXAMPLE 3

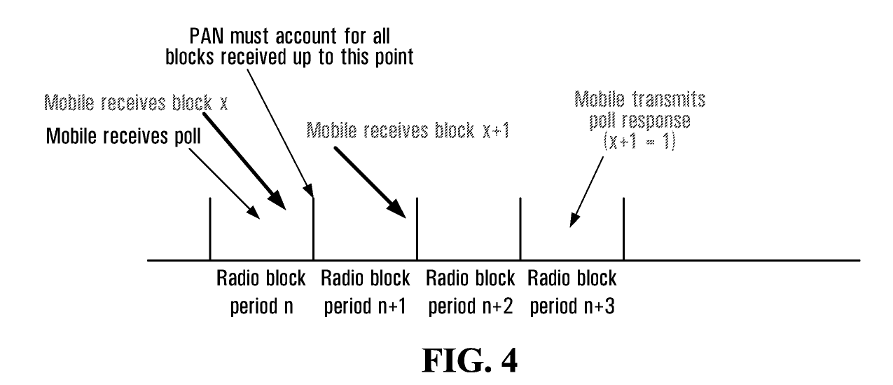

Note that the above examples are based on the current specifications, whereby ‘padding’ bits are set to ‘0’, which is the same as used for NACKs. If padding bits are set to ‘1’ and all ‘1’ bits are ignored (similarly to how PANs received by the mobile station are interpreted), a similar problem arises as shown by way of example in FIG. 4. Here, the ‘1’ indication is ambiguous. It could be a padding bit, or an ACK indication for block x+1.

### EXAMPLE 4

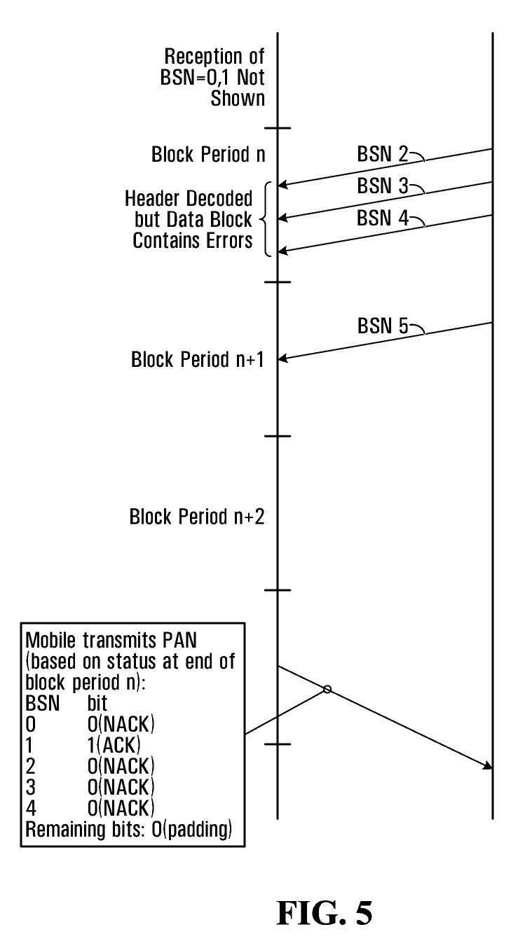

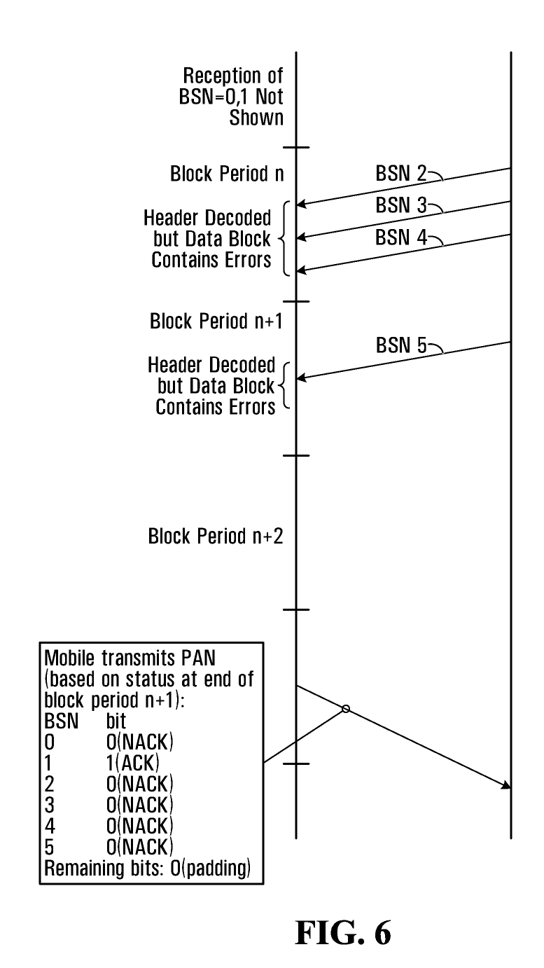

Another example will be described with reference to FIGS. 5 and 6. In FIG. 5, the mobile station transmits PAN based on the status at the end of block period n. In this case, BSN (block sequence number) 5 could have been received correctly or not, but in any event the PAN does not include ACK/NACK for BSN 5. In FIG. 6, the mobile station transmits PAN based on the status at the end of block period n+1. It can be seen that in FIG. 6, a “0 (NACK)” is transmitted for BSN 5, and that in FIG. 5, in the same position, a padding bit “0” is sent; the network would receive exactly the same thing in the two cases, and cannot distinguish between the two cases.

Disadvantageously, there is no specification as to which blocks shall/may be reported by means of event-based PANs (in terms of block periods during which those blocks were received).

Furthermore, the mobile station keeps track of which missing blocks it has reported to the network (see Event-based FANR in Background section). Under event-based FANR rules, mobile stations will stop sending Event-based PANs if they have no UNREPORTED blocks. However, due to the confusion as to which radio block periods the mobile station has taken into account, the following may arise:

if the mobile station does consider, say, block period n+1 when building the PAN, then any missing blocks identified as a result of receptions during that period will (after sending the PAN) be considered REPORTED

however, the network may misinterpret these indications since by assuming that the bits corresponding to these blocks are padding bits.

As a result, the efficiency of the event-based FANR breaks down, because the mobile station believes that it has informed the network of some missing blocks, but the network misinterprets the indication and does not act on these NACKs.

For poll-based PAN transmissions, in what follows, a “questionable radio block period” is a radio block period that is subsequent to a radio block period within which a poll was sent, and prior to the radio block period within which the PAN is transmitted. For RTTI, there are two such radio block periods, referred to as radio block periods n+1 and n+2, where the poll was transmitted during radio block period n, and for BTTI, there is one such radio block period, referred to as radio block period n+1, where the poll was transmitted during radio block period n. The number of questionable radio block periods can be different (greater than or less than) from what is set out above if the reaction time of the mobile station is changed, for example as described for some of the examples below in which the number of questionable radio block periods is reduced.

Similarly, for event-based PAN transmissions, in what follows, a “questionable radio block period” is a radio block period that is subsequent to a radio block period within which the mobile station determines that there is a block missing, and prior to the radio block period within which the event-based PAN is transmitted. For RTTI, there are two such radio block periods, and for BTTI, there is one such radio block period. A specific detailed implementation specification for some of the examples that follow is provided in Detailed Example B.

### Network Ignores Information Relating to Questionable Radio Block Periods

In some embodiments, the network is configured to ignore information relating to “questionable” radio block periods. In the event the mobile station did send an ACK or NACK in respect of a block transmitted during a questionable radio block period, the network will not process this, and will likely re-send the block. For RTTI, the network will ignore the portion(s) of the bitmap that would correspond to blocks transmitted during radio block periods n+1, n+2, while for BTTI, the network will ignore the portion(s) of the bitmap that would correspond to block(s) transmitted during period n. The portions that are ignored may or may not be contiguous and may or may not come at the end of the bitmap; in some cases there may be higher BSNs which are unambiguously reported, while the status of some lower number BSNs are questionable.

### Configure the Mobile Station to not Report on Blocks Received During the Radio Block Period Immediately Preceding the Transmission of the PAN

With this embodiment, the mobile station is configured to not report on blocks received during the radio block period immediately preceding the transmission of the PAN. Recall that for RTTI, assuming a response time of 3, the questionable radio block periods may include radio block periods n+1 and n+2. Radio block period n+2 is immediately before the transmission of the PAN in radio block period n+3, and as such with this approach, the mobile station is configured to not send PAN in respect of any blocks received during radio block period n+2. In other words, radio block period n+2 is no longer a questionable radio block period.

Recall that for BTTI, assuming a response time of one, the questionable radio block periods include radio block period block n+1. Radio block period n+1 is immediately before the transmission of the PAN in radio block period n+2, and as such with this approach, the mobile station is configured to not send PAN in respect of radio block period n+1. In other words, radio block period n+1 is no longer a questionable radio block period. In effect, there are no questionable radio block periods for BTTI.

The defined response time for RTTI or BTTI may be changed (from 3 and 2 respectively). In this case, the number of questionable radio block periods for this method would change accordingly. For example, if the response time was 3 for BTTI, then the mobile station would not report on blocks in radio block period n+2, but may report on blocks in radio block period n+1 so there is one questionable block period.

In some embodiments, this approach is combined with the above described embodiment in which the network ignores information relating to questionable radio block periods. In this case, ignoring information corresponding to the questionable radio block period(s) has a smaller effect on the efficiency of the FANR algorithm than currently (because there are fewer questionable radio block periods).

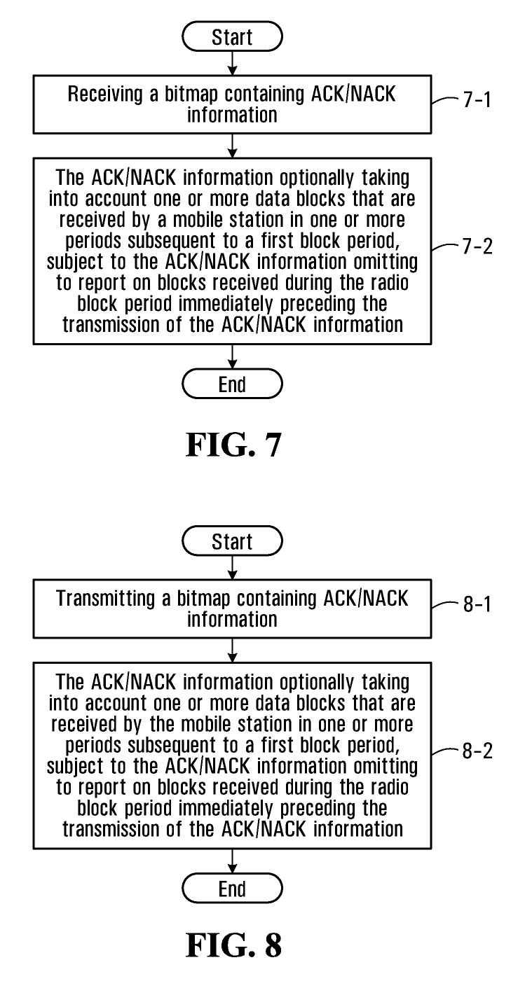

A flowchart of a method for implementation in a network, for example by one or more components of the network will now be described with reference to FIG. 7. The method begins in block 7-1 with receiving a bitmap containing ACK/NACK information. As indicated at block 7-2, the ACK/NACK information optionally takes into account one or more data blocks that are received by a mobile station in one or more periods subsequent to a first block period, subject to the ACK/NACK information omitting to report on blocks received during the radio block period immediately preceding the transmission of the ACK/NACK information.

The corresponding method for implementation by a mobile station will now be described with reference to FIG. 8. The method begins at block 8-1 with transmitting a bitmap containing ACK/NACK information. As indicated in block 8-2, the ACK/NACK information optionally takes into account one or more data blocks that are received by the mobile station in one or more periods subsequent to a first block period, subject to the ACK/NACK information omitting to report on blocks received during the radio block period immediately preceding the transmission of the ACK/NACK information.

### Validate Information Relating to Questionable Radio Block Periods.

Under the existing coding, padding and NACKs may be indistinguishable and/or it may be impossible to determine if a transmission of a block during a questionable radio block period (that had been previously transmitted) has been considered in constructing the bitmap. However, if an ACK is transmitted (bit=1), and it can be validated that the ACK bit is in respect of a block which was transmitted during a questionable radio block period (so that the network could be sure that the ACK corresponded to that transmission, and not an earlier transmission of the same block) then the network deduces that the mobile station had taken into account that questionable radio block period (and any earlier questionable radio block periods). The network can then make use of any ACK/NACK information in respect of radio blocks transmitted during the questionable block period(s) thus validated knowing that the mobile station had taken into account transmissions received during that questionable block period(s).

The validation of a questionable radio block period (QBP) may, for example, depend on the fact that:
a bit sent corresponding to a block (with BSN=b) received in the QBP is not the same as a padding bit
*and* the network is sure that the bit corresponds to the reception of block b during the QBP, and not some earlier reception of block b.

For example, if the padding bits are 0s (also used for NACKs), it requires that
a bit sent corresponding to block b sent in the QBP is set to 1 (=ACK)
and, either:
this is the first possible reception of block b (because it was the first transmission by the network)
or, the most recent previous reception failed and was NACKed. (If this condition is not met, the network does not know whether i) the mobile station is treating blocks in the QBP and block b in that period was received correctly, or ii) the mobile station is not treating blocks in the QBP and the mobile station is reporting the state of the earlier transmission of block b).

If it is not possible to validate this questionable radio block period, then the network assumes that the mobile station is not taking into account those transmissions.

A similar approach can be implemented if the coding is reversed (so that padding uses ‘1’ bits, rather than ‘0’ bits). In this case, validation requires a NACK/0 bit to correspond to a transmission during the questionable radio block period.

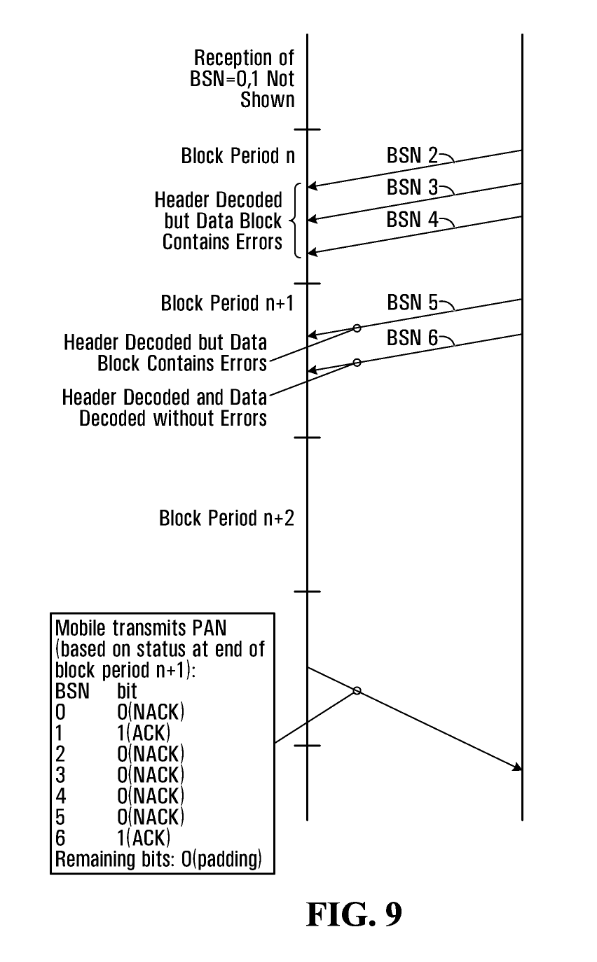

FIG. 9 depicts an example of validation. Here, due to the inclusion of a “1” in respect of radio block 6, the network knows that the mobile station received block 6 during block period n+1; the only way the mobile station could indicate an ACK for that block is if it was taking into account blocks received during radio block period n+1; therefore the network knows that the 0 bit corresponding to BSN 5 must be a NACK, not a padding bit.

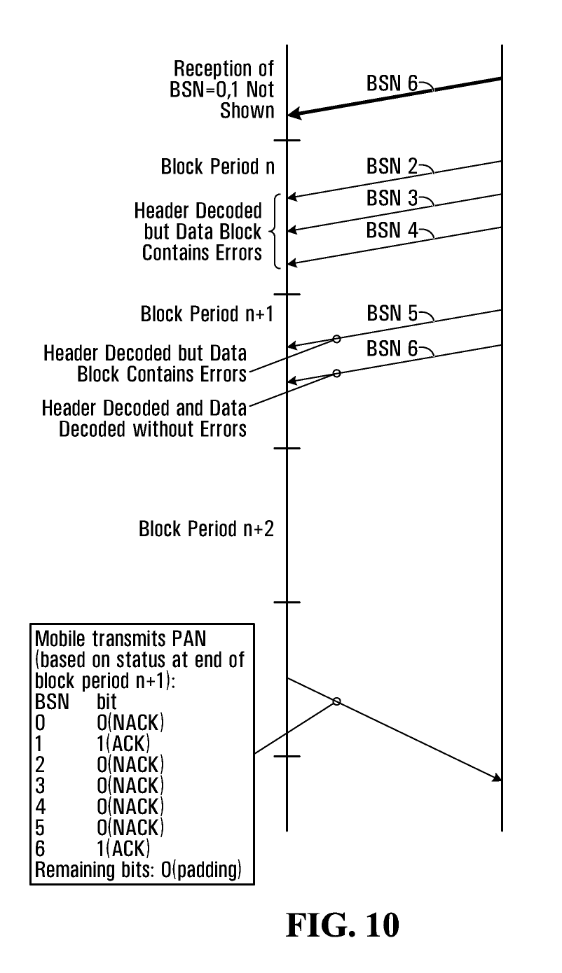

FIG. 10 shows an example of where the network is unable to validate. Here, the network had sent block 6 earlier (say in block period n−1). In this case, the mobile station could be ACK'ing block 6 based on the copy received in block period n−1, therefore the network cannot determine whether the mobile station is taking into account blocks received in period n+1.

However, if the mobile station had previously (unambiguously) NACK'ed the first transmission of block 6 so that the network is aware that the transmission of block 6 in period n−1 was unsuccessful, then the ACK in the PAN must correspond to the transmission in period n+1 and other indications for that block period can be validated.

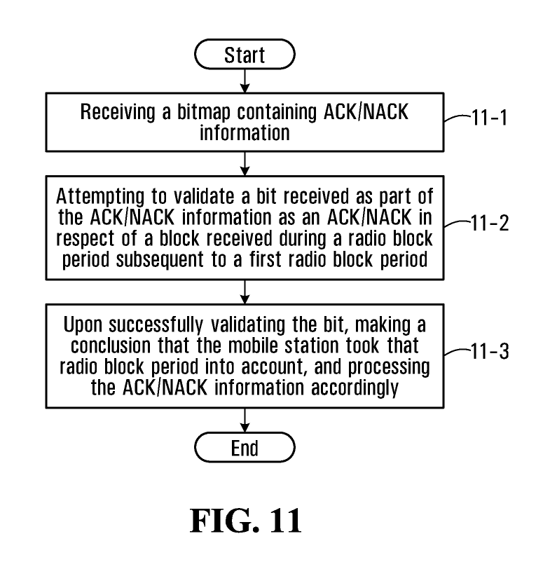

A method for execution in a network, for example by one or more network components, will now be described with reference to FIG. 11. The method begins at block 11-1 with receiving a bitmap containing ACK/NACK information. The method continues in block 11-2 with attempting to validate a bit received as part of the ACK/NACK information as an ACK/NACK in respect of a block received during a radio block period subsequent to a first radio block period. The method continues in block 11-3 with upon successfully validating the bit, making a conclusion that the mobile station took that radio block period into account, and processing the ACK/NACK information accordingly.

### Determine Mobile Station Capability Based on Validation

In this solution, the mobile station is mandated to apply the same behaviour consistently over a period of time (e.g. throughout a TBF, or from the receipt of one assignment message that modified assigned resources to the next assignment message that modifies assigned resources). Initially, the network assumes that the mobile station is not taking into account those transmissions received during the questionable radio block period(s).

If any questionable radio block period is validated (for example as described above under the heading “Validate” information relating to questionable radio block periods”, then the network stores that information and considers all corresponding future questionable blocks to have been validated.

For example, the network may determine as a result of receiving a particular PAN that the mobile station takes into account blocks received during radio block period n+1; then all subsequent block periods “n+1” are considered to be taken into account by the mobile station; i.e. on an ongoing basis, the PAN takes account of blocks received during the radio block period within with the poll was transmitted, and the following radio block period.

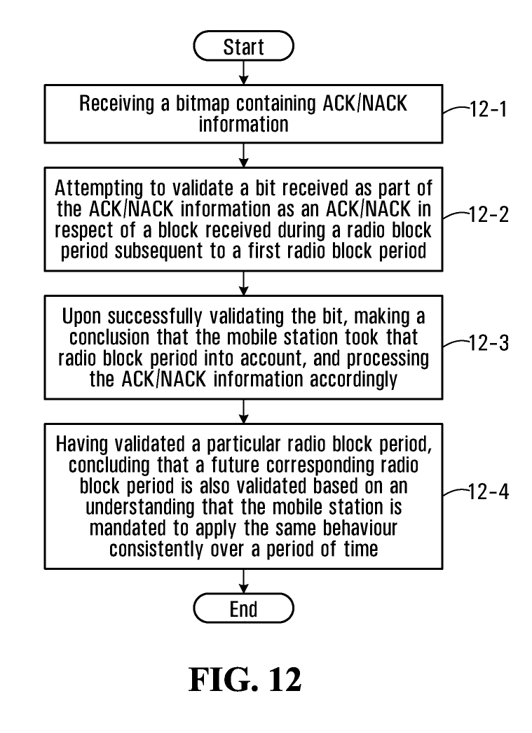

A method for execution by a network, for example by one or more network devices, will now be described with reference to FIG. 12. The method begins at block 12-1 with receiving a bitmap containing ACK/NACK information. The method continues in block 12-2 with attempting to validate a bit received as part of the ACK/NACK information as an ACK/NACK in respect of a block received during a radio block period subsequent to a first radio block period. The method continues in block 12-3 with upon successfully validating the bit, making a conclusion that the mobile station took that radio block period into account, and processing the ACK/NACK information accordingly. The method continues in block 12-4 with having validated a particular radio block period, concluding that a future corresponding radio block period is also validated based on an understanding that the mobile station is mandated to apply the same behaviour consistently over a period of time.

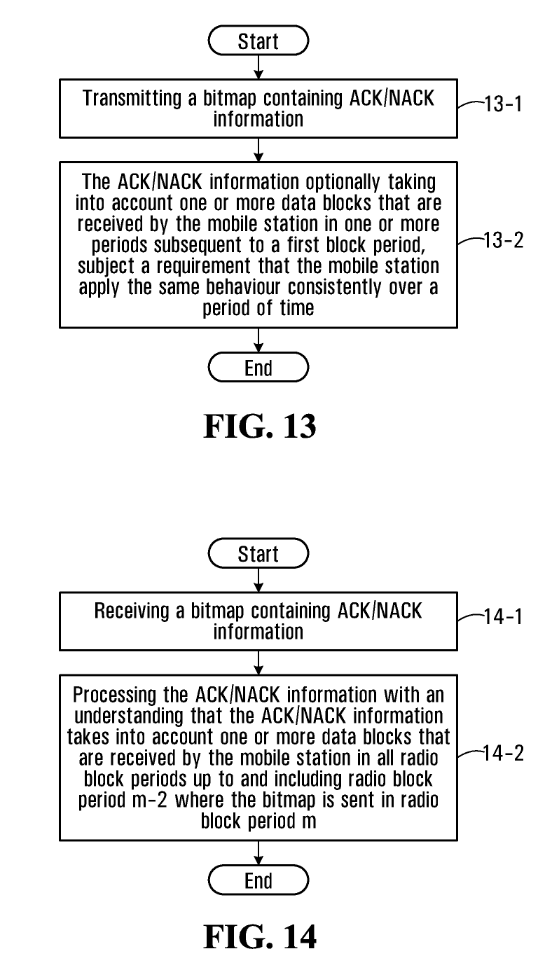

A corresponding method for execution by a mobile device will now be described with reference to FIG. 13. The method begins in block 13-1 with transmitting a bitmap containing ACK/NACK information. The method continues in block 13-2 with the ACK/NACK information optionally taking into account one or more data blocks that are received by the mobile station in one or more periods subsequent to a first block period, subject a requirement that the mobile station apply the same behaviour consistently over a period of time.

### Reduce the Permitted “Questionable” Blocks in Event-Based PAN.

In some embodiments, for event-based PANs the mobile station is configured to take into account all radio block periods up to and including radio block period m−2 where the PAN is sent in radio block period m.

A method for execution in a network, for example for one or more network components, will now be described with reference to FIG. 14. The method begins in block 14-1 with receiving a bitmap containing ACK/NACK information. The method continues in block 14-2 with processing the ACK/NACK information with an understanding that the ACK/NACK information takes into account one or more data blocks that are received by the mobile station in all radio block periods up to and including radio block period m−2 where the bitmap is sent in radio block period m.

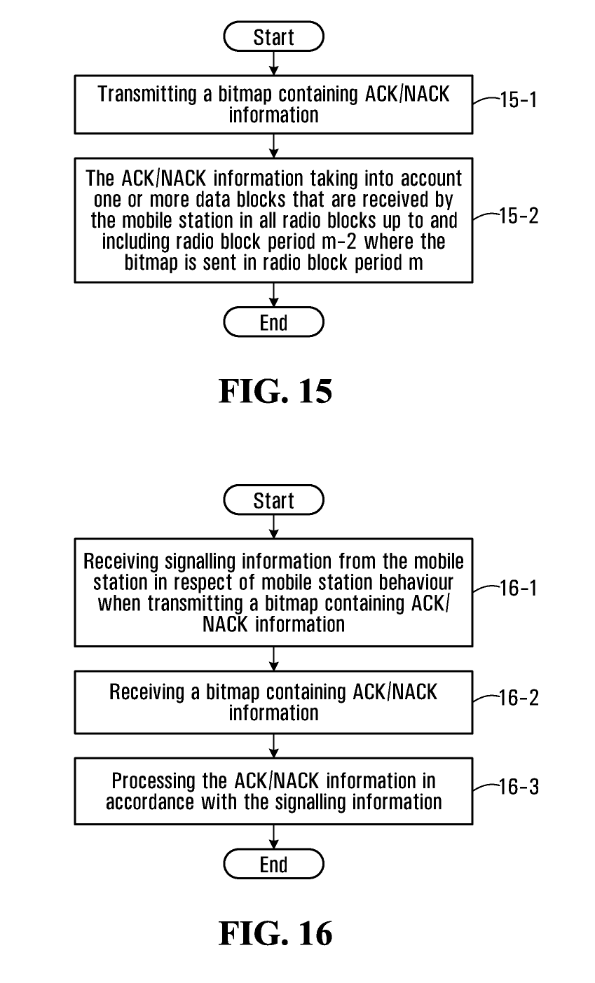

A corresponding method for execution by a mobile device will now be described with reference to FIG. 15. The method begins in block 15-1 with transmitting a bitmap containing ACK/NACK information. The method continues in block 15-2 with the ACK/NACK information taking into account one or more data blocks that are received by the mobile station in all radio blocks up to and including radio block period m−2 where the bitmap is sent in radio block period m.

### Signal Mobile Station Capability

In some embodiments, rather than have the network make a determination, for example based on the ‘validation’ solutions described above, the mobile station signals its capability (in terms of reaction time and/or which block periods it considers when reporting PANs). Although this would require additional signaling, it would simplify network implementation and avoid any ambiguity. The network then takes the signaling into account, and processes received PAN information accordingly.

Signaling could be by means of the MS Radio Access Capabilities IE (see 3GPP TS 24.008), or within RLC/MAC control blocks, such as the EGPRS Packet Downlink ACK/NACK control message. A specific example of an information element containing this information is provided in Detailed Example C. This may, or example, be sent in various messages. Specific examples include an ATTACH REQUEST message, ROUTING AREA UPDATE message, etc.—these messages are defined in 24.008.

A method for execution by a network, for example by one or more network components, will now be described with reference to FIG. 16. The method begins in block 16-1 with receiving signaling information from the mobile station in respect of mobile station behaviour when transmitting a bitmap containing ACK/NACK information. The method continues in block 16-2 with receiving a bitmap containing ACK/NACK information. The method continues in block 16-3 with processing the ACK/NACK information in accordance with the signaling information.

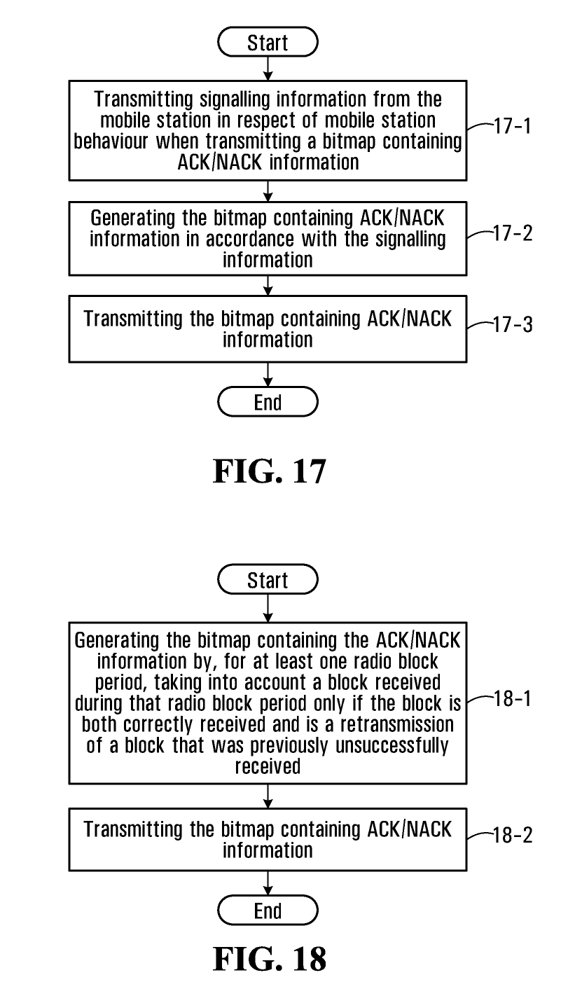

A corresponding method for execution by a mobile device will now be described with reference to FIG. 17. The method begins in block 17-1 with transmitting signaling information from the mobile station in respect of mobile station behaviour when transmitting a bitmap containing ACK/NACK information. The method continues in block 17-2 with generating the bitmap containing ACK/NACK information in accordance with the signaling information. The method continues in block 17-3 with transmitting the bitmap containing ACK/NACK information.

### Signal Network Capability or Expectation

In some embodiments, to further minimize any misinterpretation of ACK/NACK information, the network signals to the mobile station how the mobile station is expected to report ACK/NACK information. In some embodiments, the network indicates that the mobile station shall behave in a specific manner, or that the mobile shall behave according to whatever capability the mobile signals to the network.

Explicit signaling may be, for example, by means of broadcast system information blocks (e.g. in the GPRS Cell Options IE see 3GPP TS 44.060) or in assignment messages (e.g. PACKET DOWNLINK ASSIGNMENT message, see 3GPP TS 44.060).

In some embodiments, the absence of any explicit signaling indicates that a mobile is to behave in a particular manner, for example, to not take into account any blocks received during questionable radio block periods

### Transmit ACKs for Blocks Received During Questionable Radio Block Periods

In some embodiments, a mobile station which is otherwise not taking into account a particular radio block period (or at least, not required to take into account a particular radio block period), nevertheless takes into account a block correctly received during that radio block period if a previous transmission of that block was unsuccessfully received, and thereby, instead of reporting a NACK (corresponding to the earlier transmission(s)) reports an ACK for that block. Since the network is expecting a report for that block (because of the earlier transmission(s)) then it would process a NACK (and not, for example, consider a ‘0’ bit as padding) and may retransmit the block. However, by replacing the NACK indication by an ACK indication, the network knows that no further transmission is necessary. For the functioning of the RLC protocol in general, it is not necessary that the mobile station identify which transmission(s) of a given block were correctly received and hence there is no problem in this case that the mobile station is reporting an ACK based on the reception of a block which the network would not have expected the mobile station to have taken into account when constructing the bitmap.

In some embodiments, this solution is applied regardless of any signaling received from the network indicating how the mobile should construct ACK/NACK bitmaps.

This solution has the benefit of minimizing unnecessary transmissions of blocks, including in particular pre-emptive retransmissions.

A flowchart of a method for execution by a mobile station will now be described with reference to FIG. 18. The method begins in block 18-1 with generating the bitmap containing ACK/NACK information by, for at least one radio block period, taking into account a block received during that radio block period only if the block is both correctly received and is a retransmission of a block that was previously unsuccessfully received. The method continues in block 18-2 with transmitting the bitmap containing ACK/NACK information.

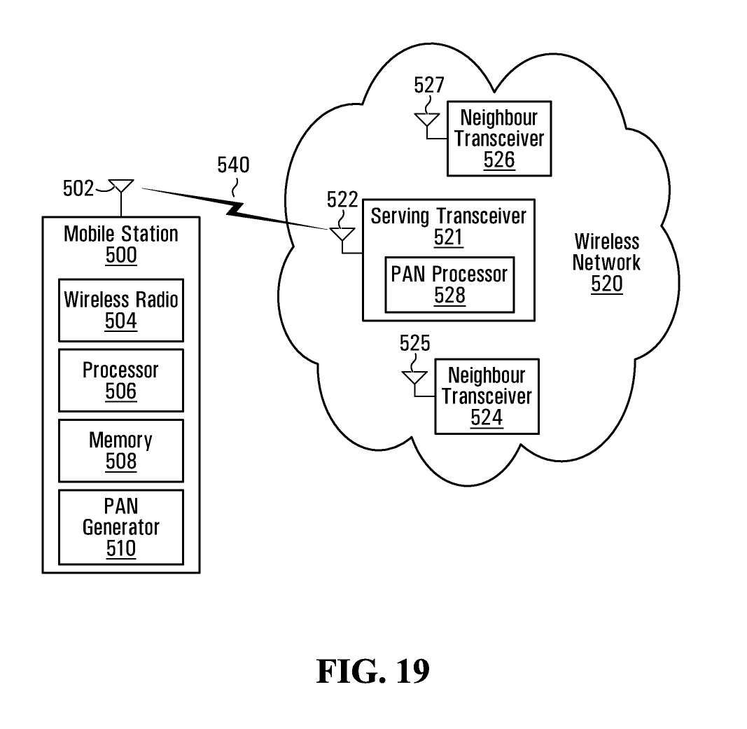

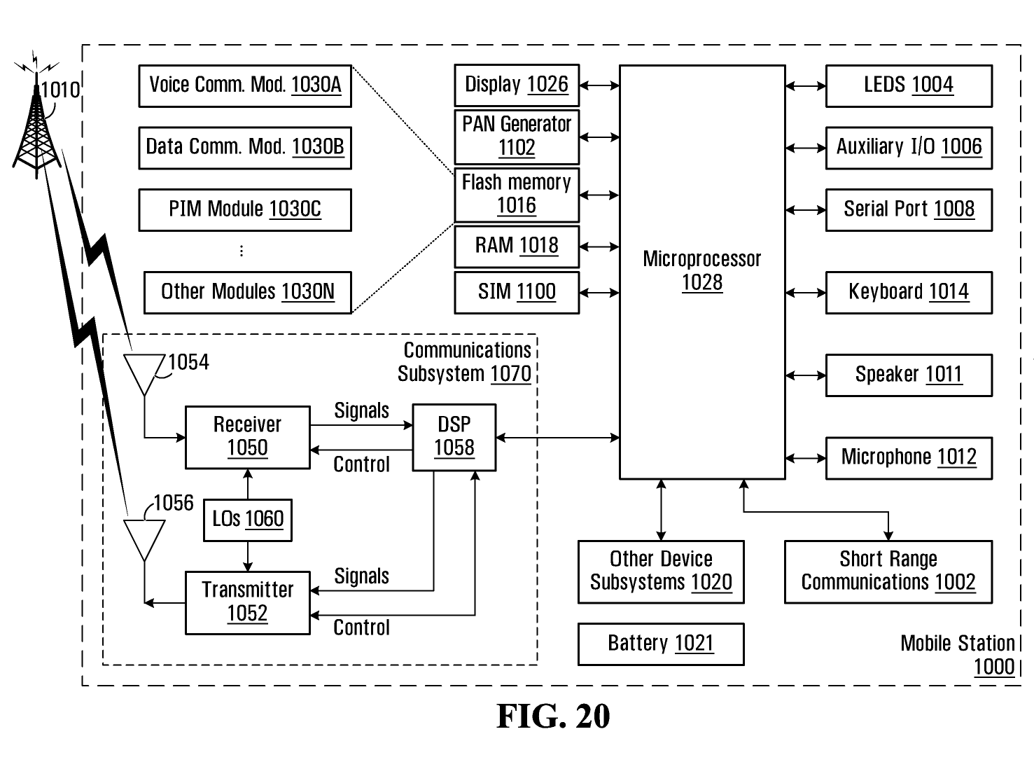

Referring to FIG. 19, shown is a block diagram showing a mobile station 500 and a network providing wireless communication services. The mobile station 500 has at least one antenna 502, a processor 506, wireless radio 504 and device memory 508 which may include non-volatile RAM, ROM and or volatile RAM. The mobile station is shown with a single wireless radio 504, but in some embodiments, the mobile station may have multiple such wireless radios, for example if the mobile station is a multi-mode mobile station. The mobile station 500 has a PAN generator 510. Of course, the mobile station may have additional components to those shown, and the components shown may be arranged/combined/implemented differently than shown.

The mobile station 500 is configured, through inclusion of the PAN generator 510 which may be implemented in suitable hardware, firmware, and/or or software stored in device memory 508, to perform any of the methods described above.

The network 520 is shown to include a serving transceiver 521 having at least one antenna 522. At the instant depicted, the mobile station 500 is obtaining wireless communications services via transceiver 521. Also shown are two neighbour transceivers 524,526 with associated antennas 525,527. Transceivers 521,525,526 may, for example for part of respective base stations. The network 520 has a PAN processor 528 responsible for implementing any of the network side methods described herein. The functionality of the PAN processor may reside in the serving transceiver 521 or elsewhere in the network.

In the illustrated example, the PAN processor is implemented as software and executed on processors forming part of the network 520. However, more generally, the PAN processor may be implemented as software running on appropriate tangible processing platform, hardware, firmware, or any appropriate combination thereof.

Furthermore, it is to be understood that the network 520 would have any appropriate components suitable for a network providing wireless communications services. Note that the network 520 may include wires that interconnect network components in addition to components for providing wireless communication with mobile stations. The components of the network 520 are implementation specific and may depend on the type of wireless network. There are many possibilities for the wireless network. The wireless network might for example be a GSM network.

In operation, the mobile station 500 communicates with the wireless network 520 over a wireless connection 540 between the mobile station 500 and the serving transceiver 521. The PAN generator 510 of the mobile station 500 and the PAN processor of the network 520 participates in the generation and processing of PAN information, in accordance with one or more of the methods described above.

Referring now to FIG. 10, shown is a block diagram of another mobile station 1000 that may implement mobile station related methods described herein. It is to be understood that the mobile station 1000 is shown with very specific details for example purposes only. The mobile station 1000 has a PAN generator 1102 which functions as per the PAN generator 510 of FIG. 9 described above.

A processing device (a microprocessor 1028) is shown schematically as coupled between a keyboard 1014 and a display 1026. The microprocessor 1028 controls operation of the display 1026, as well as overall operation of the mobile station 1000, in response to actuation of keys on the keyboard 1014 by a user.

The mobile station 1000 has a housing that may be elongated vertically, or may take on other sizes and shapes (including clamshell housing structures). The keyboard 1014 may include a mode selection key, or other hardware or software for switching between text entry and telephony entry.

In addition to the microprocessor 1028, other parts of the mobile station 1000 are shown schematically. These include: a communications subsystem 1070; a short-range communications subsystem 1002; the keyboard 1014 and the display 1026, along with other input/output devices including a set of LEDS 1004, a set of auxiliary I/O devices 1006, a serial port 1008, a speaker 1011 and a microphone 1012; as well as memory devices including a flash memory 1016 and a Random Access Memory (RAM) 1018; and various other device subsystems 1020. The mobile station 1000 may have a battery 1021 to power the active elements of the mobile station 1000. The mobile station 1000 is in some embodiments a two-way radio frequency (RF) communication device having voice and data communication capabilities. In addition, the mobile station 1000 in some embodiments has the capability to communicate with other computer systems via the Internet.

Operating system software executed by the microprocessor 1028 is in some embodiments stored in a persistent store, such as the flash memory 1016, but may be stored in other types of memory devices, such as a read only memory (ROM) or similar storage element. In addition, system software, specific device applications, or parts thereof, may be temporarily loaded into a volatile store, such as the RAM 1018. Communication signals received by the mobile station 1000 may also be stored to the RAM 1018.

The microprocessor 1028, in addition to its operating system functions, enables execution of software applications on the mobile station 1000. A predetermined set of software applications that control basic device operations, such as a voice communications module 1030A and a data communications module 1030B, may be installed on the mobile station 1000 during manufacture. In addition, a personal information manager (PIM) application module 1030C may also be installed on the mobile station 1000 during manufacture. The PIM application is in some embodiments capable of organizing and managing data items, such as e-mail, calendar events, voice mails, appointments, and task items. The PIM application is also in some embodiments capable of sending and receiving data items via a wireless network 1010. In some embodiments, the data items managed by the PIM application are seamlessly integrated, synchronized and updated via the wireless network 1010 with the device user's corresponding data items stored or associated with a host computer system. As well, additional software modules, illustrated as other software module 1030N, may be installed during manufacture. In addition, the microprocessor 1028 executes SRI updating and SRI reading functions.

Communication functions, including data and voice communications, are performed through the communication subsystem 1070, and possibly through the short-range communications subsystem 1002. The communication subsystem 1070 includes a receiver 1050, a transmitter 1052 and one or more antennas, illustrated as a receive antenna 1054 and a transmit antenna 1056. In addition, the communication subsystem 1070 also includes a processing module, such as a digital signal processor (DSP) 1058, and local oscillators (LOs) 1060. The specific design and implementation of the communication subsystem 1070 is dependent upon the communication network in which the mobile station 1000 is intended to operate. For example, the communication subsystem 1070 of the mobile station 1000 may be designed to operate with the Mobitex™, DataTAC™ or General Packet Radio Service (GPRS) mobile station data communication networks and also designed to operate with any of a variety of voice communication networks, such as Advanced Mobile station Phone Service (AMPS), Time Division Multiple Access (TDMA), Code Division Multiple Access CDMA, Personal Communications Service (PCS), Global System for Mobile station Communications (GSM), etc. Other types of data and voice networks, both separate and integrated, may also be utilized with the mobile station 1000.

Network access may vary depending upon the type of communication system. For example, in the Mobitex™ and DataTAC™ networks, mobile stations are registered on the network using a unique Personal Identification Number (PIN) associated with each device. In GPRS networks, however, network access is typically associated with a subscriber or user of a device. A GPRS device therefore typically has a subscriber identity module, commonly referred to as a Subscriber Identity Module (SIM) card, in order to operate on a GPRS network.

When network registration or activation procedures have been completed, the mobile station 1000 may send and receive communication signals over the communication network 1010. Signals received from the communication network 1010 by the receive antenna 1054 are routed to the receiver 1050, which provides for signal amplification, frequency down conversion, filtering, channel selection, etc., and may also provide analog to digital conversion. Analog-to-digital conversion of the received signal allows the DSP 1058 to perform more complex communication functions, such as demodulation and decoding. In a similar manner, signals to be transmitted to the network 1010 are processed (e.g., modulated and encoded) by the DSP 1058 and are then provided to the transmitter 1052 for digital to analog conversion, frequency up conversion, filtering, amplification and transmission to the communication network 1010 (or networks) via the transmit antenna 1056.

In addition to processing communication signals, the DSP 1058 provides for control of the receiver 1050 and the transmitter 1052. For example, gains applied to communication signals in the receiver 1050 and the transmitter 1052 may be adaptively controlled through automatic gain control algorithms implemented in the DSP 1058.

In a data communication mode, a received signal, such as a text message or web page download, is processed by the communication subsystem 1070 and is input to the microprocessor 1028. The received signal is then further processed by the microprocessor 1028 for an output to the display 1026, or alternatively to some other auxiliary I/O devices 1006. A device user may also compose data items, such as e-mail messages, using the keyboard 1014 and/or some other auxiliary I/O device 1006, such as a touchpad, a rocker switch, a thumb-wheel, or some other type of input device. The composed data items may then be transmitted over the communication network 1010 via the communication subsystem 1070.

In a voice communication mode, overall operation of the device is substantially similar to the data communication mode, except that received signals are output to a speaker 1011, and signals for transmission are generated by a microphone 1012. Alternative voice or audio I/O subsystems, such as a voice message recording subsystem, may also be implemented on the mobile station 1000. In addition, the display 1016 may also be utilized in voice communication mode, for example, to display the identity of a calling party, the duration of a voice call, or other voice call related information.

The short-range communications subsystem 1002 enables communication between the mobile station 1000 and other proximate systems or devices, which need not necessarily be similar devices. For example, the short-range communications subsystem may include an infrared device and associated circuits and components, or a Bluetooth™ communication module to provide for communication with similarly-enabled systems and devices.

Numerous solutions have been defined for RTTI and BTTI. It is to be understood that each embodiment may be applied to one or both or RTTI and BTTI. In some implementations, a first solution is applied for RTTI, and a second different solution is applied for BTTI.

Similarly, numerous solutions have been provided that have focused on PANs sent in response to a poll. These solutions can also be applied to event-based PAN. In some implementations, a first solution (or pair of solutions) is used for PANs sent in response to a poll, and a second solution (or pair of solutions) is used for event-based PAN.

### DETAILED EXAMPLE A

In a specific example, SSN-based PANs are coded as shown below (extract from 44.060).

1.1 10.3a.5 Piggy-Backed Ack/Nack Field (SSN-Based)

When the SSN-based encoding is used (see sub-clause 9.1.14.1), the Piggy-backed Ack/Nack (PAN) field consists of a beginning of window (BOW), a short starting sequence number (ShortSSN), a reported bitmap (RB) and a temporary flow identifier (TFI) fields. In the downlink direction, the TFI field shall always include a valid value. In the uplink direction, the TFI field shall include a valid value only if multiple TBF procedures are supported by both the network and the mobile station; in all other cases, the bits of the TFI field shall be set to ‘0’. The length of the PAN field is 25 bits. The size of the ShortSSN field varies between 7 and 11 bits as defined in sub-clause 10.4.23. The remaining bits in the PAN field are reserved for the reported bitmap with a size varying between 8 and 12 bits.

The order of bits is as for the UNCOMPRESSED_RECEIVE_BLOCK_BITMAP field in the EGPRS Ack/Nack Description information element (see sub-clause 12.3.1) i.e. the lowest order bit in the RB field corresponds to the block with the sequence number from which the ShortSSN is derived.

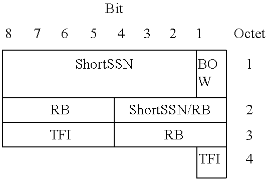

FIG. 10.3a.5.1: Piggy-Backed Ack/Nack Field (SSN-Based)

1.2>>>>>End Quote

1.3>>>>>Begin Quote

In case of polled FANR (see sub-clause 9.1.14.2), SSN [shortSSN is SSN truncated, see below] shall be set to V(Q)+1. [V(Q) is the lowest BSN that has not been received yet]

In case of event-based FANR, the SSN shall be set to the following value (where BSN′ is the BSN of the oldest RLC data block of which the corresponding element in V(N) [V(N) is the array of elements, one per BSN, each being one of RECEIVED/REPORTED/UNREPORTED] has the value UNREPORTED, and N is the number of bits in the bitmap):
the higher of V(Q)+1 and V(R)−N [V(R) is the next block expected, i.e. the lowest that has not yet been detected at all], provided that the bitmap includes BSN′, else
BSN′+1, if V(Q) is equal to BSN′, else
BSN′, if V(Q) is not equal to BSN′.

The ShortSSN shall then be set to the value of the L least significant bits of SSN. The number L of bits is determined as defined in sub-clause 10.4.23.

1.4>>>>>End Quote

The BOW bit is defined:

1.5>>>>>Begin Quote

1.5.1 10.4.22 Beginning of Window (BOW) Field

The BOW (begin of window) bit shall be set if SSN=[V(Q)+1] modulo SNS.

1.6>>>>>End Quote

### EXAMPLE

the mobile station has received all blocks up to and including BSN=24

the mobile station has received correctly blocks 26,27; it has previously reported the fact that it has not received 25; and has received the header only of block 28; it has never seen BSN 29

based on the window size, L is 9, therefore the bitmap contains 10 bits (which may include padding) since the bitmap+shortSSN=19 bits (so N=10)

This gives V(Q)=25; V(R)=29. The array V(N) looks like:

| | | | Corresponding | | Bit |
|---|---|---|---|---|---|
| 1. | BSN | 2. | V(N) element | 3. | to go in bitmap |
| 4. | 25 | 5. | REPORTED | 6. | 0 |
| 7. | 26 | 8. | RECEIVED | 9. | 1 |
| 10. | 27 | 11. | RECEIVED | 12. | 1 |
| 13. | 28 | 14. | UNREPORTED | 15. | 0 |

Therefore an event-based PAN is constructed as follows (using the rules in 9.1.8.2.2a quoted above):

BSN′ (oldest unreported block)=28

higher of (V(Q)+1) [=26] and (V(R)−N) [=19]=26; a bitmap starting at 26 will include BSN′.

So, SSN=26 and hence the Short SSN is the last 9 bits of this i.e. 000011010

Since SSN=V(Q)+1, then BOW=1 (i.e. we are starting with the oldest block that is still missing) (see 10.4.22 above)

Since BOW=1, the receiver of the PAN will know that we are starting at the beginning of the window, so the lowest missing BSN (25 in this case) is *implicitly* NACKed, and the bitmap starts with BSN 26.

Therefore the PAN will contain:
Short SSN=000011010
BOW=1
Bitmap=1100000000 (underlined 0s are padding) (increasing BSNs from left to right)

### DETAILED EXAMPLE B

1.6.1.1.1 44.060, v.7.15.0

Below is the full text of sub-clause 9.1.8.2.3. Text in [. . . ] is understood/implicit and not explicit in the current specifications. Suggested changes to the highlighted text are given below for the various options.

1.6.1.1.2 9.1.8.2.3 Generation of the Bitmap

First, a Full Received Bitmap (FRB) is built from the receive state array V(N) by extracting the part between V(Q) and V(R) similar to the GPRS case: it is assigned the elements whose indices in the receive state array V(N) at the receiver range from [V(Q)+1] to [V(R)−1] (modulo SNS). For each bit in the bitmap, the bit is assigned the value ‘1’ if the corresponding element in V(N) indexed relative to SSN has the value RECEIVED. The bit is assigned the value ‘0’ if the element in V(N) has the value INVALID. For a TBF with FANR activated, the bit is assigned the value ‘0’ also if the element in V(N) has the value UNREPORTED or REPORTED.

For EGPRS TBFs (excluding downlink dual carrier configuration or TBFs running in RLC non-persistent mode), the same principles and implementation options as for GPRS apply regarding the determination of V(R).

For EGPRS TBFs using downlink dual carrier configuration, with FANR activated or using EGPRS2 and for EGPRS TBFs running in RLC non-persistent mode, when the mobile station is polled, [the bitmap shall be constructed, and] V(R) shall be determined taking into account all RLC data blocks received up to and including those received in the radio block period where the poll is received. As an implementation option, the mobile station may also consider RLC data blocks that are received in following radio block periods, taking into account all RLC data blocks received in those radio block periods.

From the FRB, a reported bitmap (RB) shall then be generated. The FRB shall be recalculated before each RB is generated, except that PAN fields transmitted during the same radio block period for the same TBF shall be based on the same FRB and the FRB shall therefore not be recalculated between the generation of these PAN fields. Different lengths of RBs exist (see clause 12 and sub-clause 10.3a.5). For uplink TBFs, the network may transmit any RB size to the mobile station. For downlink TBFs, the network may order the mobile station to transmit a certain RB size through use of the ES/P field. The bitmap size may be selected based on e.g. risk of protocol stalling. The RB in a PAN field is always uncompressed. In PACKET UPLINK ACK/NACK, EGPRS PACKET DOWNLINK ACK/NACK and EGPRS PACKET DOWNLINK ACK/NACK TYPE 2 messages, the RB is one of the following types:
a) Uncompressed reported bitmap:
   If the range of indices from SSN to the end of FRB is less than or equal to N bits, where N is the reported bitmap size, the RB starts at SSN and covers the range of indices from SSN to the end of FRB. When an RB is a part of a PAN field, if the number of indices from SSN to the end of FRB is less than N bits and the reported bitmap is generated by the mobile station, the bits not covering the FRB shall be set to the value ‘0’. When an RB is a part of a PAN field, if the number of indices from SSN to the end of FRB is less than N bits and the reported bitmap is generated by the network, the bits not covering the FRB shall be set to the value ‘1’. If the range of indices from SSN to the end of FRB is greater than N bits, the RB is assigned the first N bits of the FRB starting at SSN.
b) Compressed reported bitmap:
   Using the compression algorithm, the receiver generates RB of length N bits starting at SSN, where N is the reported bitmap size used.

If the compressed reported bitmap covers more blocks than the uncompressed reported bitmap, the receiver shall send the compressed reported bitmap, otherwise the receiver shall send the uncompressed reported bitmap. As an exception, if the FRB length or the range of indices from SSN to the end of FRB is less than or equal to N bits, the receiver may send the uncompressed reported bitmap without attempting compression.

The BOW (begin of window) bit shall be set if SSN=[V(Q)+1] modulo SNS, the EOW (end of window) bit shall be set if [V(R)−1] modulo SNS is explicitly included in the bitmap.

If V(Q) equals V(R), then SSN shall be set to the value SSN=[V(Q)+1] modulo SNS, BOW bit shall be set to the value ‘1’, EOW shall be set to the value ‘1’ and the reported bitmap size shall equal 0 bits.

For uplink TBFs, the reported bitmap is sent using the PACKET UPLINK ACK/NACK message corresponding to the used RB size.

For downlink TBFs the reported bitmap is sent using the EGPRS PACKET DOWNLINK ACK/NACK TYPE 2 message (for mobile stations with one or more downlink TBFs using EGPRS2) or EGPRS PACKET DOWNLINK ACK/NACK message (otherwise). For MBMS bearers the reported bitmap is sent using the MBMS DOWNLINK ACK/NACK message.

For Polled PANs, Replace the Italicized Underlined Text with One of the Following:

Option 4:

For EGPRS TBFs using downlink dual carrier configuration, with FANR activated or using EGPRS2 and for EGPRS TBFs running in RLC non-persistent mode, when the mobile station is polled, V(R) shall be determined taking into account all RLC data blocks received up to and including those received in the radio block period where the poll is received. As an implementation option, the mobile station may also consider RLC data blocks that are received in following radio block periods, taking into account all RLC data blocks received in those radio block periods; in this case, the mobile station shall apply this option consistently during a TBF as long as the TTI of the uplink resources remains the same i.e. if a PAN is transmitted in block period n, and the bitmap and V(R) take account of RLC data blocks received during and prior to radio block period n−a, the same value of a shall be used.

Option 5: (Note this is Written for Polled PANs)

For EGPRS TBFs using downlink dual carrier configuration or using EGPRS2 and for EGPRS TBFs running in RLC non-persistent mode, when the mobile station is polled or for TBFs with FANR activated if the poll response is other than by means of a PAN, V(R) shall be determined taking into account all RLC data blocks received up to and including those received in the radio block period where the poll is received. As an implementation option, the mobile station may also consider RLC data blocks that are received in following radio block periods, taking into account all RLC data blocks received in those radio block periods.

For TBFs with FANR activated when the mobile station is polled and a PAN is sent in response to the poll, the bitmap and V(R) shall be determined taking into account all RLC data blocks received up to and including those received in radio block period (n−2) where the PAN is transmitted in radio block period n.

Option 6 (Signaling in MS RAC):

For EGPRS TBFs using downlink dual carrier configuration or using EGPRS2 and for EGPRS TBFs running in RLC non-persistent mode, when the mobile station is polled or for TBFs with FANR activated if the poll response is other than by means of a PAN, V(R) shall be determined taking into account all RLC data blocks received up to and including those received in the radio block period where the poll is received. As an implementation option, the mobile station may also consider RLC data blocks that are received in following radio block periods, taking into account all RLC data blocks received in those radio block periods.

For TBFs with FANR activated when the mobile station is polled and a PAN is sent in response to the poll, the bitmap and V(R) shall be determined taking into account all RLC data blocks received up to and including those received in radio block period (n−POLL_{—}RESPONSE_RT) where the PAN is transmitted in radio block period n and where POLL_RESPONSE_RT is signaled to the network in the MS Radio Access Capabilities IE (see 3GPP TS 24.008).

Option 6 (Signaling in EGPRS PDAN):

For EGPRS TBFs using downlink dual carrier configuration or using EGPRS2 and for EGPRS TBFs running in RLC non-persistent mode, when the mobile station is polled or for TBFs with FANR activated if the poll response is other than by means of a PAN, V(R) shall be determined taking into account all RLC data blocks received up to and including those received in the radio block period where the poll is received. As an implementation option, the mobile station may also consider RLC data blocks that are received in following radio block periods, taking into account all RLC data blocks received in those radio block periods.

For TBFs with FANR activated when the mobile station is polled and a PAN is sent in response to the poll, the bitmap and V(R) shall be determined taking into account all RLC data blocks received up to and including those received in radio block period (n−POLL_RESPONSE_RT) where the PAN is transmitted in radio block period n and where POLL_RESPONSE_RT is signaled by the mobile station to the network in an EGPRS PACKET DOWNLINK ACK/NACK message or EGPRS PACKET DOWNLINK ACK/NACK TYPE 2 message. If no POLL_RESPONSE_RT indication has yet been sent for this downlink TBF, a value of 3 (for RTTI) and 2 (for BTTI) shall apply.

Event-based PANs: For any of the above options, equivalent procedures can be specified for event-based PANs, where the radio block where the missing block(s) are detected is equivalent to the radio block in which the poll is received. The same or different options can be used for polled and event-based PANs. If option 4 is used for both, then the value of a may be the same or different. If different options (or different values of a) are used, if a PAN is to be sent in a given radio block according to both polled and event-based FANR rules, then the rules for polled PAN shall apply.

### DETAILED EXAMPLE C

1.6.1.2 10.5.5.12a MS Radio Access Capability

The purpose of the MS Radio Access capability information element is to provide the radio part of the network with information concerning radio aspects of the mobile station. The contents might affect the manner in which the network handles the operation of the mobile station.

The MS Radio Access capability is a type 4 information element, with a maximum length of 52 octets.

The value part of a MS Radio Access capability information element is coded a shown table 10.5.146/3GPP TS 24.008.

For the indication of the radio access capabilities the following conditions shall apply:
Among the three Access Type Technologies GSM 900-P, GSM 900-E and GSM 900-R only one shall be present.
Due to shared radio frequency channel numbers between GSM 1800 and GSM 1900, the mobile station should provide the relevant radio access capability for either GSM 1800 band OR GSM 1900 band, not both.
The MS shall indicate its supported Access Technology Types during a single MM procedure.
If the alternative coding by using the Additional access technologies struct is chosen by the mobile station, the mobile station shall indicate its radio access capability for the serving BCCH frequency band in the first included Access capabilities struct, if this information element is not sent in response to an Access Technologies Request from the network or if none of the requested Access Technology Types is supported by the MS. Otherwise, the mobile station shall include the radio access capabilities for the frequency bands it supports in the order of priority requested by the network (see 3GPP TS 44.060 [76]).
The first Access Technology Type shall not be set to “1111”.

For error handling the following shall apply:
If a received Access Technology Type is unknown to the receiver, it shall ignore all the corresponding fields.
If within a known Access Technology Type a receiver recognizes an unknown field it shall ignore it.
For more details about error handling of MS radio access capability see 3GPP TS 48.018 [86].
NOTE: The requirements for the support of the A5 algorithms in the MS are specified in 3GPP TS 43.020 [13].

TABLE 10.5.146/3GPP TS 24.008
MS Radio Access Capability Information Element

<MS RA capability value part : < MS RA capability value part struct >>
<spare bits>**; -- may be used for future enhancements
<MS RA capability value part struct >::= --recursive structure allows any number of Access
technologies

| { | { | < Access Technology Type: bit (4) > exclude 1111 | |
|---|---|---|---|
| | | < Access capabilities : <Access capabilities struct> > | |
| } | | | |
| \| | { | < Access Technology Type: bit (4) == 1111 > | -- |

structure adding Access technologies with same capabilities

| | |
|---|---|
| < Length : bit (7) > | -- |

length in bits of list of Additional access technologies and spare bits

{ 1 < Additional access technologies: < Additional

access technologies struct > > } ** 0

<spare bits>** } }

```
    { 0 | 1 <MS RA capability value part struct> } ;
< Additional access technologies struct > ::=
    < Access Technology Type : bit (4) >
    < GMSK Power Class : bit (3) >
    < 8PSK Power Class : bit (2) > ;
< Access capabilities struct > ::=
    < Length : bit (7) > -- length in bits of Content and spare bits
    <Access capabilities : <Content>>
    <spare bits>** ; -- expands to the indicated length
```

-- may be used for future enhancements

```
< Content > ::=
    < RF Power Capability : bit (3) >
    { 0 | 1 <A5 bits : <A5 bits> > } -- zero means that the same values apply for
parameters as in the immediately preceding Access capabilities field within this IE
    < ES IND : bit >
    < PS : bit >
    < VGCS : bit >
    < VBS : bit >
    { 0 | 1 < Multislot capability : Multislot capability struct > } -- zero means that the same
values for multislot parameters as given in an earlier Access capabilities field within this IE apply also
here
-- Additions in release 99
    { 0 | 1 < 8PSK Power Capability : bit(2) >}
    < COMPACT Interference Measurement Capability : bit >
    < Revision Level Indicator : bit >
    < UMTS FDD Radio Access Technology Capability : bit >
```

-- 3G RAT

| | |
|---|---|
| < UMTS 3.84 Mcps TDD Radio Access Technology Capability : bit > | -- 3G |

RAT
< CDMA 2000 Radio Access Technology Capability : bit >

-- 3G RAT

-- Additions in release 4

| | |
|---|---|
| < UMTS 1.28 Mcps TDD Radio Access Technology Capability: bit > | -- 3G |

```
RAT
    < GERAN Feature Package 1 : bit >
    { 0 | 1 < Extended DTM GPRS Multi Slot Class : bit(2) >
```

< Extended DTM EGPRS Multi Slot Class : bit(2) > }

```
    < Modulation based multislot class support : bit >
-- Additions in release 5
    { 0 | 1 < High Multislot Capability : bit(2) > }
    { 0 | 1 < GERAN lu Mode Capabilities > }
  < GMSK Multislot Power Profile : bit (2) >
    < 8-PSK Multislot Power Profile : bit (2) >
-- Additions in release 6
    < Multiple TBF Capability : bit >
    < Downlink Advanced Receiver Performance : bit(2) >
    < Extended RLC/MAC Control Message Segmentation Capability : bit >
    < DTM Enhancements Capability : bit >
```

| | |
|---|---|
| { 0 \| 1 | < DTM GPRS High Multi Slot Class : bit(3) > |

{ 0 | 1 < DTM EGPRS High Multi Slot Class : bit(3) >

```
} }
    < PS Handover Capability : bit >
-- Additions in release 7
    < DTM Handover Capability : bit >
    { 0 | 1 < Multislot Capability Reduction for Downlink Dual Carrier: bit (3) >
```

< Downlink Dual Carrier for DTM Capability : bit> }

```
    < Flexible Timeslot Assignment : bit >
  < GAN PS Handover Capability : bit >
    < RLC Non-persistent Mode : bit >
    < Reduced Latency Capability : bit >
    < Uplink EGPRS2 : bit(2) >
    < Downlink EGPRS2 : bit(2) >
-- Additions in release 8
    < E-UTRA FDD support : bit >
    < E-UTRA TDD support : bit >
    < GERAN to E-UTRAsupport in GERAN packet transfer mode: bit(2) >
-- Additions in release 9
```

| | |
|---|---|
| { 0 | -- PAN reaction time |

(RTTI) = 2 radio block periods

< PAN encoding capability (RTTI) : bit >

| | |
|---|---|
| \| 1 | -- PAN reaction time |

(RTTI) = 1 radio block period
}

| | |
|---|---|
| { 0 | -- EGPRS PDAN |

reaction time (RTTI) = 2 radio block periods

< EGPRS PDAN encoding capability (RTTI) : bit >

| | |
|---|---|
| \| 1 | -- EGPRS PDAN |

```
reaction time (RTTI) = 1 radio block period
    };
    -- error: struct too short, assume features do not exist
    -- error: struct too long, ignore data and jump to next Access technology
[..]unchanged text omitted
GERAN to E-UTRA support in GERAN packet transfer mode (2 bit field)
This field indicates the capabilities supported by the mobile station in packet transfer mode for
GERAN to E-UTRA interworking. If both “E-UTRA FDD support” and “E-UTRA TDD support” bits
are set to ‘0’, the bit field shall be set to ‘0 0’. If one or both of “E-UTRA FDD support” and “E-
UTRA TDD support” bits are set to ‘1’, the bit field may be any of the listed values. The bit field is
coded as follows:
Bit
2 1
```

| | |
|---|---|
| 0 0 | None |
| 0 1 | E-UTRAN Neighbour Cell measurements and MS autonomous cell |

reselection to E-UTRAN supported

| | |
|---|---|
| 1 0 | CCN towards E-UTRAN, E-UTRAN Neighbour Cell measurement |

reporting and Network controlled cell

reselection to E-UTRAN supported in addition to capabilities

indicated by ‘01’

| | |
|---|---|
| 1 1 | PS Handover to E-UTRAN supported in addition to capabilities |

```
indicated by ‘01’ and ‘10’
PAN reaction time (RTTI) = 2 radio block periods
If this capability is indicated then:
    if FANR is enabled for a downlink TBF, the mobile station shall respond in radio
block period n+3 to a poll for PAN received in radio block period n ,
    if event-based FANR is enabled for a downlink TBF, the mobile station shall be
ready to transmit a PAN in radio block period n+3 in response the detection of a missing block in
block period n.
PAN encoding capability (RTTI) (1 bit field)
bit
0 the mobile station shall take into account all blocks received during radio blocks up
to and including radio block  period n when constructing the PAN response.
1  the mobile station shall take into account all blocks received during radio blocks up
to and including radio block  period n+1 when constructing the PAN response.
PAN reaction time (RTTI) = 1 radio block period
If this capability is indicated then:
    if FANR is enabled for a downlink TBF, the mobile station shall respond in radio
block period n+2 to a poll for PAN received in radio block period n ,
    if event-based FANR is enabled for a downlink TBF, the mobile station shall be
ready to transmit a PAN in radio block period n+2 in response the detection of a missing block in
block period n.
    in either case, the mobile station shall take into account all blocks received during
radio blocks up to and including radio block period n when constructing the PAN response.
EGPRS PDAN reaction time (RTTI) = 2 radio block periods
EGPRS PDAN encoding capability (RTTI)
EGPRS PDAN reaction time (RTTI) = 1 radio block period
These indications / fields are the same as defined for PANs above, but apply to the transmission of
EGPRS PACKET DOWNLINK ACK/NACK messages or EGPRS PACKET DOWNLINK TYPE 2
messages during a downlink TBF with FANR enabled.
```

Numerous modifications and variations of the present disclosure are possible in light of the above teachings. It is therefore to be understood that within the scope of the appended claims, the disclosure may be practiced otherwise than as specifically described herein.

We claim:

1. A method in a network, the method comprising:
receiving signaling information from a mobile station, the signaling information indicating which radio block periods are considered by a mobile station when generating a bitmap containing ACK/NACK (acknowledgement/negative acknowledgement) information;
receiving a bitmap containing ACK/NACK information;
processing the ACK/NACK information in accordance with the signaling information.

2. The method of claim 1 wherein:
receiving a bitmap containing ACK/NACK information comprises receiving a bitmap that contains at least one bit known to be an ACK/NACK bit and that contains at least one bit that may be an ACK/NACK bit or a padding bit;
the signaling information allows a determination of whether the at least one bit that may be an ACK/NACK bit or a padding bit is an ACK/NACK bit or a padding bit.

3. The method of claim 1 wherein:
receiving a bitmap containing ACK/NACK information comprises receiving a bitmap that contains at least one bit that may be an ACK/NACK bit in respect of only a first transmission of a data block, or may be an ACK/NACK bit in respect of at least a second transmission of the data block;
the signaling information allows a determination of whether the at least one bit is an ACK/NACK bit in respect of a first transmission of a data block, or is an ACK/NACK bit in respect of a second transmission of the data block.

4. The method of claim 1 wherein:
receiving a bitmap containing ACK/NACK information comprises receiving a bitmap that contains at least one bit that may or may not be an ACK/NACK bit taking into account a first transmission of a data block;
the signaling information allows a determination of whether the at least one bit is an ACK/NACK bit taking into account a first transmission of a data block.

5. The method of claim 1 wherein the signaling information indicates a reaction time when generating ACK/NACK information.

6. The method of claim 1 wherein processing the ACK/NACK information in accordance with the signaling information comprises:
processing the bitmap as if it includes ACK/NACK information for all data blocks received by the mobile station up to and including those received in radio block period (n−a) where the bitmap is transmitted by the mobile station in radio block period n, where the signaling information indicates a.

7. The method of claim 1 further comprising:
receiving the signaling information together with the bitmap.

8. The method of claim 1 further comprising:
receiving the signaling information in an EGPRS PACKET DOWNLINK ACK/NACK message or EGPRS PACKET DOWNLINK ACK/NACK TYPE 2 message.

9. The method of claim 6 further comprising:
if no indication of a has yet been received, applying a first default value for RTTI (reduced transmit time interval) and a second default value for BTTI (basic transmit time interval).

10. A method in a mobile station, the method comprising:
transmitting signaling information from the mobile station in respect of mobile station behaviour when generating a bitmap containing ACK/NACK information, the signaling information indicating which radio block periods are considered when generating the bitmap;
generating a bitmap containing ACK/NACK information in accordance with the signaling information; and
transmitting the bitmap containing ACK/NACK information.

11. The method of claim 10 wherein:
transmitting a bitmap containing ACK/NACK information comprises transmitting a bitmap that contains at least one bit known to be an ACK/NACK bit and that contains at least one bit that may be an ACK/NACK bit or a padding bit;
the signaling information indicates whether the at least one bit that may be an ACK/NACK bit or a padding bit is an ACK/NACK bit or a padding bit.

12. The method of claim 10 wherein:
transmitting a bitmap containing ACK/NACK information comprises transmitting a bitmap that contains at least one bit that may be an ACK/NACK bit in respect of a first transmission of a data block, or may be an ACK/NACK bit in respect of a second transmission of the data block;
the signaling information allows a determination of whether the at least one bit is an ACK/NACK bit in respect of a first transmission of a data block, or is an ACK/NACK bit in respect of a second of the data block.

13. The method of claim 10 wherein:
transmitting a bitmap containing ACK/NACK information comprises transmitting a bitmap that contains at least one bit that may or may not be an ACK/NACK bit taking into account a first transmission of a data block;
the signaling information allows a determination of whether the at least one bit is an ACK/NACK bit taking into account a first transmission of a data block.

14. The method of claim 10 wherein:
the signaling information indicates a reaction time when transmitting ACK/NACK information.

15. The method of claim 10 wherein:
generating the bitmap comprises generating the bitmap so as to include all data blocks received up to and including those received in radio block period (n−a) where the bitmap is transmitted in radio block period n, where the signaling information indicates a.

16. The method of claim 10 further comprising:
transmitting the signaling information together with the bitmap.

17. The method of claim 10 further comprising:
transmitting the signaling information in an EGPRS PACKET DOWNLINK ACK/NACK message or EGPRS PACKET DOWNLINK ACK/NACK TYPE 2 message.

18. The method of claim 15 further comprising:
if indication of a has not yet been transmitted, applying a first default value for RTTI and a second default value for BTTI.

19. The method of claim 1 wherein the bitmap containing ACK/NACK information is contained within a piggy-backed ACK/NACK (PAN) field.

20. A mobile station configured to execute the method of claim 10.

21. A computer readable medium having computer executable instructions stored thereon, which, when executed on a mobile station, result in the execution of the method of claim 10.

22. One or more network components configured to execute the method of claim 1.

23. A computer readable medium having computer executable instructions stored thereon, which, when executed on one or more network components, result in the execution of the method of claim 1.
